(19) United States
(12) Patent Application Publication
(10) Pub. No.: US 2002/0085897 A1
(43) Pub. Date: Jul. 4, 2002

(54) Binding process for manufacturing brochures

(76) Inventors: Thomas Blattner, Schwaikheim (DE); Herbert Saum, Kuchen (DE); Kurt Stehle, Bad Waldsee (DE); Hans-Peter Wurschum, Ostfildern (DE); Michael Freund, Adelberg (DE); Klaus Hermann, Ostfildern (DE); Alexander Hirsch, Kirchheim (DE); Mario Litsche, Felbach (DE); Bernd Reibl, Geislingen (DE); Albert Rieger, Geislingen (DE)

Correspondence Address: Kevin L. Leffel, Heidelberg Digital L.L.C., 2600 Manitou Road, Rochester, NY, 14624, US

(21) Appl. No.: 09/994,741

(22) Filed: Nov. 28, 2001

(30) Foreign Application Priority Data
Nov. 13, 2001 (EP) 01126528.7
Nov. 29, 2000 (DE) 10059344.5
Aug. 27, 2001 (DE) 10141811.6

(51) Int. Cl. B42B 2/00

(52) U.S. Cl. 412/6

(57) ABSTRACT

The invention concerns a process for producing bound documents in any thickness, of the type wherein several sheets of material are loosely bound by at least one binding element, preferably formed from wire. According to an aspect of the invention, a process is provided for forming at least one binding element immediately prior to the binding process.

### BACKGROUND

The invention concerns a process for producing brochures in any thickness, of the type wherein several sheets of material are bound by a binding element.

The process for manufacturing brochures using the so-called Wire-O® binding element in various sizes, for example, is well-known from the European patent applications 0 095 243-A1 and 0 095 245-B1.

Wire-O® binding elements are defined as parallel separated wire loops with a loop length L, and loop spacing A and a wire diameter D, and are shaped into a binding ring using appropriate closing devices.

The binding devices for the above-named patent applications are designed so that it is possible to process formed Wire-O® binding elements of varying loop spacing and lengths.

In general, these devices have the disadvantage that in order to bind brochures with different formats and thicknesses, the required wire binding elements for the wire binding equipment, in the form of several pre-formed wire binding element supplies, e.g. material wound on spools or elements cut to the binding length, must be made available. A considerable number of supplies are needed in order to be able to bind the various brochure formats and thicknesses. In addition, in order to change the format of the brochures to be produced, the transportation and processing equipment must be adapted to the requirements of the different wire binding elements. This conversion requires costly designs of the transport and binding equipment, and therefore the binding process only becomes cost effective if a large number brochures are produced in one format. Smaller production runs are therefore not cost-effective and require large amounts of time to adjust the machinery.

According to DE 28 47 700-A1, there is a process for the wire binding of writing pads, etc. in which a wire is pulled continuously from a wire supply and is shaped into a wave pattern by bending it forward and backward, and whereby the wave-shaped wire pattern is then bent into a C-shape transversely to the level of the waves. Form rollers with set diameters are used for the bending so that only wire binding elements with loop spacing and loop lengths that cannot be changed are produced.

### SUMMARY OF THE INVENTION

According to one aspect of the invention, a process is provided for forming at least one binding element immediately prior to the binding process. Numerous other aspects are disclosed or apparent from the description provided herein.

### BRIEF DESCRIPTION OF THE DRAWINGS

FIG. 1 presents a schematic drawing of a process and apparatus according to an aspect of the invention.

FIG. 2 presents a plan view of a binding element of a type implemented in the practice of one aspect of the invention.

FIG. 3 presents an embodiment of a bound brochure using a single wire binding element according to an aspect of the invention.

FIG. 4 presents an embodiment of a bound brochure using multiple wire binding elements according to an aspect of the invention.

FIG. 5 presents an embodiment of a bound brochure using multiple, evenly spaced wire binding elements according to a further aspect of the invention.

FIG. 6 presents a schematic drawing of a wire supply having various wire spools, according to a further aspect of the invention.

FIG. 7 presents a schematic drawing of a crimping device with conveyor equipment used in one process, according to a further aspect of the invention, to create crimps in the wire binding elements.

### DETAILED DESCRIPTION

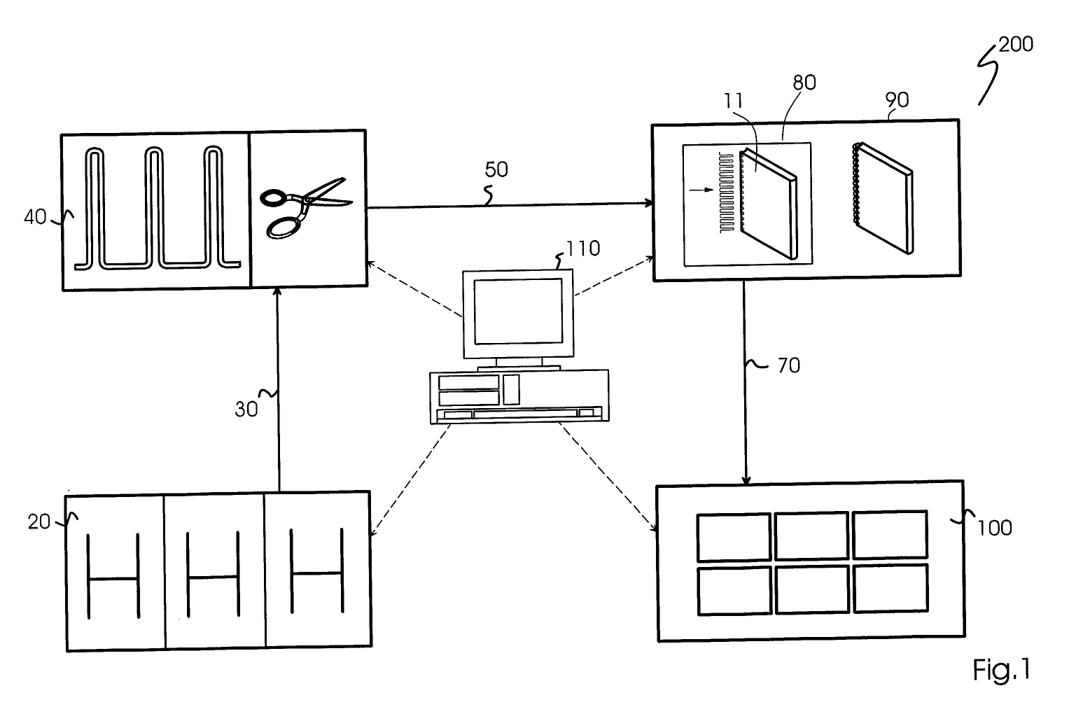

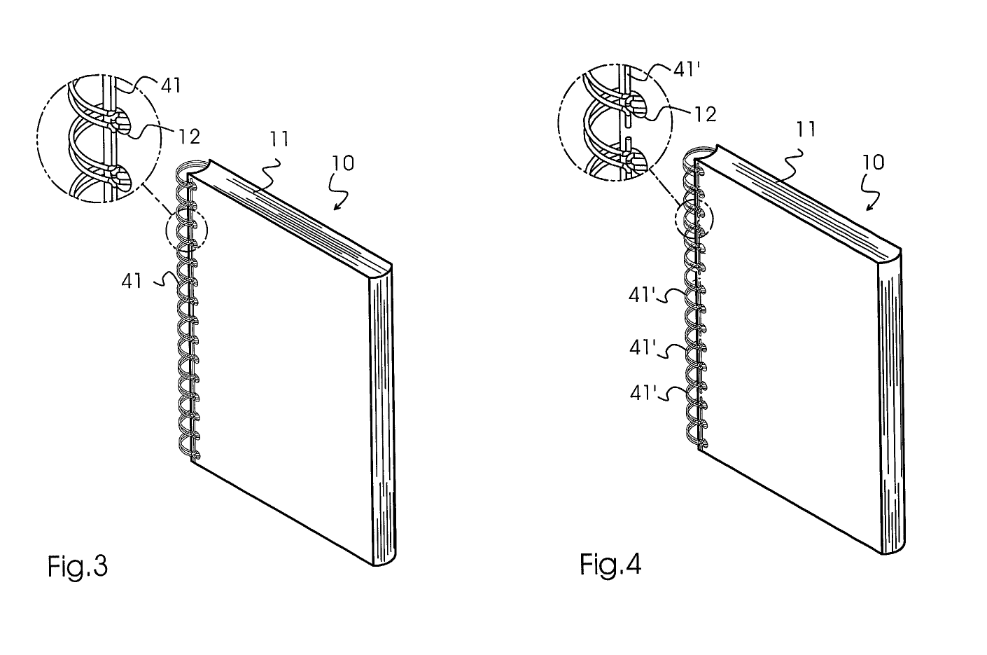

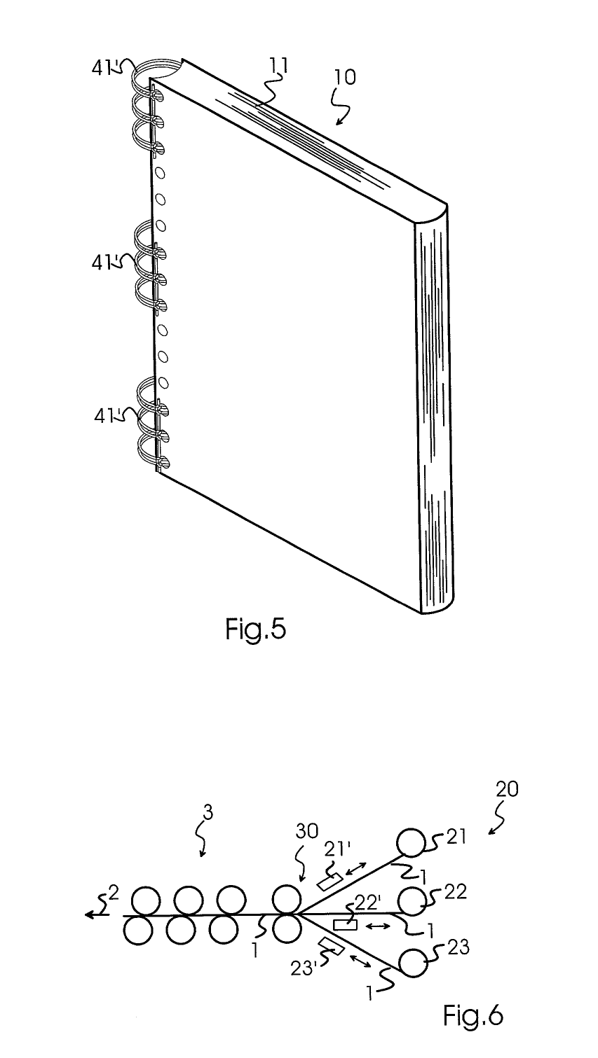

Various aspects of the invention are presented by FIGS. 1-7, which are not drawn to scale, and wherein like references in the numerous views are numbered alike. Referring now specifically to FIG. 1, a device labeled 200 according to an aspect of the invention is presented, which is used to produce brochures of varying formats and thicknesses as well as several arrangements for producing brochures of varying thicknesses or formats according to various further aspects of the invention, preferably formed from wire, and which are connected to and controlled by an electronic control device 110.

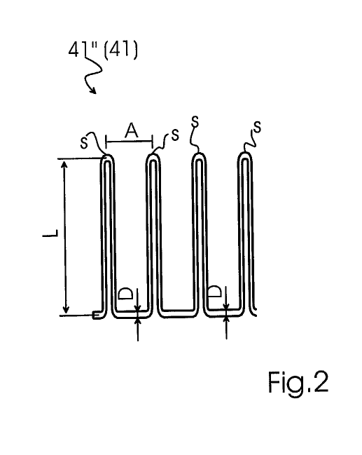

As illustrated in FIGS. 1, 2 and 6, a wire supply 20, equipped with wire supply spools 21, 22 and 23, is shown with wires 1 of varying diameters D (e.g. a diameter between 0.8 mm and 1.2 mm), for example. Wires that are painted different colors and arranged according to diameter may be used in the practice of the invention, as well as other variations, without departing from the invention. According to one aspect of the invention, a binding element 41 is formed by bringing the wire 1 into the shape of a loop S by a wire bending device 40, whereby the loop length L and the loop spacing A can be set to any value by the control unit 110. The wire bending device cuts the resulting binding element 41 after reaching the number of loops specified by the electronic control unit 110. The wire binding element 41 may take a variety of shapes, including the comb presented in FIG. 2.

A conveyor 50 transports the binding element 41 to an insertion device 80, that may include a bending and closing device 90. According to a further aspect of the invention, sheet-like material 11, which may be unprinted or printed on one or both sides is formed into a stack (superposed). The material 11 is equipped with a row of perforations 12 using a perforation device, before, during, or after stacking.

The binding element may tailored to complement the perforations, or a standard array of performations may be implemented. The binding element 41 is inserted into the row of perforations 12 of the stacked sheets of printed material 11 using an insertion device 80 and is closed into a ring-like binding by the bending and closing device 90. The stack of material 11 may then be transferred to an output device 100 by a suitable conveyor apparatus 70, where it is ejected in finished form.

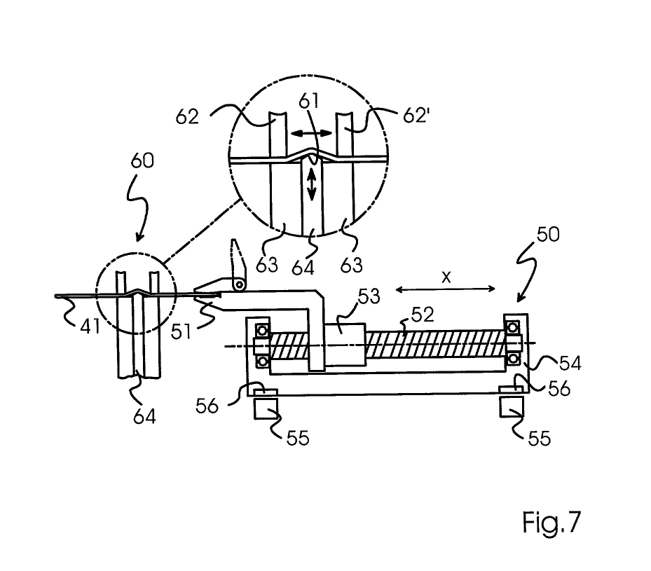

According to another embodiment, crimps 61 are made in the middle of the S loop after producing the binding element 41 using a crimping device 60. The crimping device 60, as shown schematically in FIG. 7, consists of two horizontally adjustable bending molds 62, 62′ and a vertically moving bending die 64 with a spring-like holding device 63. The bending molds can be moved concentrically to the bending die using a device that is not shown, in order to be able to bend different crimps 61 according to each loop length L. Putting the crimps 61 in the middle of the loop length L (see FIG. 2) is preferably done in stages on a loop by loop basis with a single bending die 64 by advancing the wire transport track 2 of the housing unit 54 that holds the pincers 51. Optical edge sensors (not shown) determine the middle of the loop and determine the exact position of the wire loop in the crimping device 60. The pincers that are guided by the spindle 52 can be transported across the wire transport track 2 using drive 52, which is designed as a stepper motor, as shown in FIG. 7 in column X. In order to move the housing unit 54 parallel to the wire transport track 2, the track has guide notches 55 into which the guiding pins 56 along the device's housing 200 lock. Movement parallel to the wire transport track 2 is achieved with the respective drives which are not shown. In the event that the position of the pincers 51 needs to be corrected, the drive 53 on spindle 52, which is designed as a stepper motor, is activated using electronic control device 110.

In a further embodiment, the crimping device 60 comprises a number of bending dies 64 with the matching holding devices which corresponds to the maximum brochure format that can be bound.

In a process according to one embodiment of the invention, a first step involves determining the format and thickness of the brochures to be bound.

Determining the format, thickness and type of perforation for the brochures to be bound can occur by transmitting the parameters from the preceding devices to the electronic control device 110 and/or by using a sensor device that determines and transmits the format and thickness of the brochures, and even the type of perforation if applicable, to the electronic control device 110. As used herein the term “format” is intended to mean the dimensions of the sheet being bound, length and width.

During a second step, at least one production parameter for the binding element is determined via the electronic control device 110, and in the third step, the binding element is created using electronically and mechanically interconnected equipment by:

Feeding a wire to a wire bending device from at least one wire supply which contains one wire spool;

Bending the wire into a flat, loop-shaped binding element using the wire bending device;

Cutting and trimming the binding element using a cutting device and feeding the cut binding element to an insertion device;

Feeding a stack of sheet-like printed materials with a row of perforations to the binding equipment using conveyors;

Inserting the binding element into the row of perforations in the stack of sheet-like printed materials and then bending the binding element in a facet-like manner into a ring-like binding using a bending and closing device.

Examples of production parameters include brochure thickness, wire diameter, wire length, or perforation spacing.

The process of producing brochures of various formats and thicknesses using wire binding, preferably metal wire, has many advantages. The brochures can be bound completely automatically using binding elements that are created as needed with any loop length L, width L and wire diameter D, and where the number of loops can be produced to reflect the maximum length of the brochures to be processed. Converting or adapting the binding equipment is not necessary. It is possible to bind brochures using individual binding elements, which are spaced out evenly or unevenly, which allows for a high binding speed by binding the individual elements simultaneously. The automatic production and transportation process avoids deforming the binding elements that are created as needed, so the incidences of disruption are drastically reduced in comparison with conventional devices.

A suitable wire bending device 40 is disclosed in a U.S. patent application Ser. No. x/xxx,xxx filed on even date herewith, entitled BINDING APPARATUS AND METHOD, naming Mario Litsche as inventor. A suitable closing device 90 is disclosed in U.S. patent application Ser. No. x/xxx,xxx filed on even date herewith, entitled APPARATUS AND METHOD FOR SEGMENTED BENDING OF WIRE BINDING ELEMENTS, naming Hans-Peter Wurschum as inventor. The contents of both of these applications are hereby incorporated by reference, as if set forth herein. In referencing these applications, it is not intended to limit the invention to the specific devices disclosed, since it is evident that numerous variations and additional embodiments are possible.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

What is claimed is:

1. A process for producing brochures, comprising:
inserting a binding element into perforations along the edge of a plurality of superposed sheet-like material; and
forming said binding element immediately before said inserting.

2. The process of claim 1, further comprising tailoring said binding element to complement said perforations.

3. The process of claims 1 further comprising forming a loop in said binding element and a crimp in said loop.

4. The process of claim 1 further comprising forming a series of crimps in said binding element.

5. The process of claim 1 further comprising forming several loops in said binding element, and forming a plurality of crimps in said binding element, loop by loop, with a single bending die.

6. The process of claims 1 wherein said binding element comprises a single element corresponding to a width of said brochure.

7. The process of claims 1 further comprising forming a plurality of loops in said binding element in a row that extends across a width of said brochure, and inserting said loops into said perforations at the same time.

8. The process of claim 1, further comprising determining at least one production parameter with an electronic control device.

9. The process of claim 8, wherein said binding element is formed from wire and said at least one production parameters is brochure thickness, wire diameter, wire length, or perforation spacing.

10. A process for producing brochures using wire binding, comprising:
a) determining a thickness of a brochure to be produced and storing said thickness in an electronic device;
b) producing a binding element corresponding to said thickness by
feeding a wire from at least one wire supply containing a wire spool to a wire bending device via a conveyor,
bending said wire into a flat, multiple looped binding element,
cutting said binding element and conveying it to an insertion device;
(c) supplying sheet-like material to said insertion device, said material having perforations;
(d) inserting said binding element into said perforations; and,
(e) bending said binding element into a ring-like binding.

11. The process of claim 10, further comprising tailoring said binding element to complement said perforations.

12. The process of claims 10 further comprising forming a crimp in a loop.

13. The process of claim 10 further comprising forming a series of crimps in said binding element.

14. The process of claim 10 further comprising forming a plurality of loops in said binding element and forming a plurality of crimps in said binding element, loop by loop, with a single bending die.

15. The process of claims 10 wherein said binding element comprises a single element corresponding to a width of said brochure.

16. The process of claims 10 further comprising forming several loops in said binding element in a row that extends across a width of said brochure, and inserting said loops into said perforations at the same time.

17. The process of claim 10, further comprising determining production parameters with an electronic control device.

18. The process of claim 17, further comprising producing said binding element according to one or more production parameters in addition to thickness.

19. The process of claim 18, wherein at least one of said production parameters is wire diameter, wire length, or perforation spacing.

20. A process for producing brochures using wire binding, comprising:
a) determining a thickness of a brochure to be produced and storing said thickness in an electronic device;
b) producing a binding element corresponding to said thickness by
feeding a wire from at least one wire supply containing a wire spool to a wire bending device via a conveyor,
bending said wire into a flat, multiple looped binding element,
cutting said binding element and conveying it to an insertion device;
(c) supplying sheet-like material to said insertion device, said material having perforations;
(d) inserting said binding element into said perforations immediately after producing said binding element; and,
(e) bending said binding element into a ring-like binding.
